(19) United States
(12) Patent Application Publication
(10) Pub. No.: US 2012/0094030 A1
(43) Pub. Date: Apr. 19, 2012

(54) Direct formation of highly porous gas-sensing layers by in-situ deposition of flame-made nanoparticles

(76) Inventors: Lutz Maedler, Los Angeles, CA (US); Sotiris Pratsinis, Zuerich (CH); Albert Roessler, Innsbruck (AT); Udo Weimar, Tuebingen (DE); Nicolae Barsan, Tuebingen (DE); Aleksander Gurlo, Darmstadt (DE)

(21) Appl. No.: 13/335,266

(22) Filed: Dec. 22, 2011

Related U.S. Application Data
(62) Division of application No. 11/720,943, filed on Jun. 30, 2009.

(30) Foreign Application Priority Data
Dec. 9, 2004 (EP) 04029141.1

(51) Int. Cl. C23C 4/12; C23C 4/04; B82Y 15/00

(52) U.S. Cl. 427/448; 427/446; 977/773

(57) ABSTRACT

Method of producing a gas sensor includes positioning a sensor substrate in a flame spray pyrolysis apparatus, generating an aerosol phase with sensing material nanoparticles by flame spray pyrolysis of a precursor substance, depositing the sensing material particles contained in the aerosol, in particular nanoparticles of the sensing material, onto the sensor substrate directly from the aerosol phase to form a porous sensing layer on the sensor substrate.

### CROSS-REFERENCE TO RELATED APPLICATIONS

This application is a Divisional application of U.S. patent application Ser. No. 11/720,943 filed on Jun. 30, 2009.

This application claims the benefit of priority of U.S. patent application Ser. No. 11/720,943 filed on Jun. 30, 2009, under 35 USC 119(e). The subject matter of the aforesaid U.S. patent application is explicitly incorporated herein by reference thereto.

The invention described and claimed hereinbelow is also described in European Patent Application EP 04029141.1 filed on Dec. 9, 2004. This European Patent Application, whose subject matter is incorporated here by reference, also provides the basis for a claim of priority of invention under 35 U.S.C. 119(a)-(d).

### BACKGROUND OF THE INVENTION

The invention relates to a method of producing a gas sensor.

Although many different metal oxides have been investigated as sensing materials for semi-conducting gas sensors, tin oxide (SnO₂)-based sensors are the most commonly used. Different deposition/sensitive layer fabrication techniques have already been tested. The successful sensors are generally those with thick (several tens of micrometers) nano-crystalline (about ten nanometer) films. State-of-the-art sensors are based on pre-processed powders generally obtained through wet chemistry routes such as sol-gel decomposition of organometallic precursors and hydrothermal treatment of colloidal solutions. These are further functionalized by adding small quantities of well dispersed noble metals in the form of surface additives. For these materials, deposition methods have been developed that are compatible with both classical thick-film and silicon thin-film technologies substrates.

State-of-the-art sensors have important technical limitations that are generally related to the way in which the sensitive materials are processed. For example, the wet chemistry methods employed for both preparation and functionalization of base materials are difficult to control and as a result both the size distribution in the base material, and the amount and distribution of the noble metal additives, are rather broad. This results in significant variation of gas-sensing properties from batch to batch (30% variation is common in the industry). The fabrication of the sensitive materials is labour and time intensive, with typical batch production times on the order of days with small batch volumes in the range of 100 g. Furthermore, the deposition of sensing layers, either by classical screen-printing or more sophisticated drop deposition techniques, is performed after the additional step of combining the sensitive material with organic carriers. This increases processing time and costs related to deposition equipment and handling. Recent advances have been made using electro-spray deposition for sensor applications but limitations include processing time and the required post-processing to obtain nano-crystalline material. Additionally, variations in the deposition parameters such as new layer, layer stacks (two or more layers on top of each other) or varying layer thickness are difficult to implement and require repetition of the full process.

In JP 2002 323 473 a process of depositing a functionalized covering (protective) layer on a sensing layer by means of plasma flame spraying is described. However, this process involves plasma and results in a protective instead of a sensing layer, and, therefore, is different to this invention. Furthermore, separate processing steps for creating the sensing layer and the covering layer are involved.

In JP 2002 310 983 a gas sensor is described which has an electrolyte sensing layer coated with a ceramic by plasma flame spraying. However, this process involves plasma and focuses on the enhancement of the reliability and selectivity of a solid electrolyte gas sensor, and, therefore, differs from the direct formation of a highly porous gas sensing layer as described in this invention.

### SUMMARY OF THE INVENTION

It is the object of the invention to provide a simplified method of fabricating a gas sensor.

This object is achieved by a method of producing a gas sensor in accordance with the present invention, which comprises the steps of positioning a sensor substrate in a flame spray pyrolysis apparatus, generating an aerosol phase comprising sensing material nanoparticles by a flame spray pyrolysis (FSP) of a precursor substance, and depositing the sensing material particles contained in the aerosol, in particular nanoparticles of the sensing material, onto the sensor substrate directly from the aerosol phase to form a porous sensing layer on the sensor substrate.

Flame spray pyrolysis (FSP) can be successfully employed for the preparation of metal oxide, in particular SnO₂ nanoparticles for gas-sensing applications. Single crystalline (tin) oxide particles of about 20 nm size can be produced with FSP. FSP has the advantages of direct control of particle size and the ability to completely manufacture nano-powders in a single high-temperature step without further processing of the microstructure and noble metal particle size in subsequent annealing steps in contrast to conventional spray pyrolysis or wet methods in general. The main advantage of this invention is the use of the FSP technology for directly depositing metal oxide nanoparticles, e.g. SnO₂, and/or mixed metal oxide nanoparticles (where more than one metal compound is present within a single particle), e.g. ZnO/SnO2 and/or functionalized (mixed) metal oxide nanoparticles, e.g. Pt/SnO₂ or Pt/ZnO/SnO2, from the aerosol phase onto sensor substrates.

According to the invention multiple particle deposition from the aerosol phase is achieved. FSP is used for direct (in-situ) deposition of pure and functionalized (doped) sensing materials. Functionalization is a kind of doping, i.e. a surface doping, which is different from semiconductor doping. Functionalization occurs by in-situ deposition of noble metals and/or metal oxides and/or mixed metal oxides, different from the metal oxide or mixed metal oxide of the bulk sensing layer, to the particles of the sensing layer. As mentioned above, current state-of-the-art sensors have important technical limitations, which are partly related to the deposition procedure performed after the additional step of combining the sensitive material with organic carriers. This adds both processing time and cost related to the deposition equipment and handling. Additionally, variations in the deposition parameters such as including a new layer, layer stacks (two or more layers on top of each other), or varying layer thickness or functionalization (doping) of the layers and batch production are difficult to implement and require repetition of the full process. Using the inventive in-situ FSP deposition technique eliminates these difficulties and functionalization of the sensing layers can be realized during a single processing step on ceramic (planar) and micro-machined substrates by using appropriate masks. The method is in principle applicable to all materials that are able to be synthesized by FSP, and in principle any kind of substrate may be used for gas sensor fabrication.

An inventive sensor fabrication system including a flame spray reactor may be used to produce metal oxide nanoparticles, e.g. SnO₂, and mixed metal oxide nanoparticles, e.g. ZnO/SnO2, and possibly for functionalizing of those, e.g. to produce Pt/SnO₂ Pt/ZnO/SnO2 nanoparticles by the flame spray pyrolysis (FSP) method. Product particles are directly deposited on a sensor substrate.

Product particles may be directly deposited on e.g. alumina substrates with prefabricated electrode assemblies. Each sensor substrate may consist of interdigitated electrodes, e.g. Pt-electrodes, on the front side and heater on the back side and an active sensing area of 7.0×3.5 mm². With interdigitated electrodes a low geometry factor can be achieved for a given sensor area. A mask may be used to deposit the particles within the desired sensor area. The substrate may be mounted on a water-cooled copper block equipped with a thermocouple to enable control of the substrate temperature during the deposition process. The substrate temperature may be maintained at, for example, T_{sub}=120° C. in order to avoid water condensation on the substrate. This may be done by keeping the substrate holder at a constant temperature (T_{sub}).

The deposition substrate is, for example, centred 200 mm above the nozzle in a face down orientation. At this position the gas temperature in front of the nozzle is, for example, T_{gas}=500° C. Both temperatures (T_{sub} and T_{gas}) are preferably maintained throughout the deposition process. The liquid precursor is prepared, for example, by diluting tin(II) 2-ethylhexanoic acid in toluene to obtain a 0.5 M precursor solution. For Pt/SnO₂ synthesis, appropriate amounts of platinum acetylacetonate may be added to the solution.

The sensing layer is formed by particle transport in the flame environment and deposition on the substrate. Particles are transported towards the deposition area of the substrate by free and forced convection in the free-jet of the flame. The substrate is advantageously located at the stagnation point of the impinging jet.

Although diffusion of particles is sufficient in many cases, advantageously thermophoresis is used as the main mechanism of particle transport to the sensor substrate. As thermophoresis is not particle size dependent for particles smaller than 100 nm, the particles on the sensor are identical to those generated in the flame. Even at temperature differences between the gas and the sensor surface of 50 K and less (in the case of a deposition thickness of 100 μm) thermophoresis leads to an effective layer growth rate of about 0.1 μm/s, depending on the applied flame conditions.

In-situ functionalization of metal oxide, e.g. SnO₂ nanoparticles with noble metals, e.g. Pt or Pd, is an effective method for promoting the detection of CO and is possible by the versatile FSP technique. Functionalization of metal oxide, e.g. SnO₂, nanoparticles with, for example, 0.2 wt % noble metal, e.g. Pt, is performed in a single process, in-situ, during deposition of the sensing layers. The addition of a noble metal has no influence on (tin) oxide grain size, layer thickness and porosity. Functionalization improves the sensor performance, i.e. by increasing sensor in response to CO reproducibility by signal and analytical sensitivity both in dry and humid air. High sensing layer porosity is advantageous as the porosity provides a large interfacial area between the gas and the sensing layer.

For example, (30±3) μm SnO₂ porous layer thickness and 0.2 wt % Pt/SnO₂-based sensors have analytical sensitivity to 10 ppm CO of 0.17 and 0.50, respectively. Accordingly, (30±3) μm SnO₂ and 0.2 wt % Pt/SnO₂-based sensors allow the CO detection with the precision of 7 ppm and 2 ppm, respectively at 400° C.

Comparing sensors based on the same material (pure and functionalized SnO₂) synthesized by the flame spray pyrolysis but deposited by different techniques (i.e. by screen-printing and direct FSP deposition) clearly shows the better performance of the FSP directly deposited sensors, i.e. direct (in-situ) deposition of pure and functionalized (doped) sensing materials.

Additionally, the flexibility of FSP in direct deposition of sensing layers offers a straightforward possibility to change the thickness of the deposited layer by varying the deposition time. Variation of deposition time does not change the net porosity of the layers, grain size or the chemical state of the additive, e.g. Pt. Accordingly, the FSP deposition method gives a unique possibility to adjust the sensor's characteristics by varying the deposition time and, consequently, the sensing layer thickness.

The inventive method enables the production of highly-crystalline (e.g. SnO₂) nano-powders with sub-micrometer grain sizes. The metal oxide nano-crystals may be functionalized by in-situ inclusion of noble metal clusters during the production of the nano-powders. Nano-crystalline tin-oxide can be directly in-situ deposited forming porous layers onto alumina sensor substrates. The as-obtained sensors exhibit extremely good homogeneity of the sensing layer and good sensor performance. This innovative process has obvious advantages such as superior control over the microstructure and morphology of the nano-powders compared to classical wet-chemistry methods. Furthermore, the process is clean and fast (minutes compared to days for comparable quantities) and also allows for in-situ functionalization. The direct deposition results in fully formed functionalized sensing layers on various substrates. The in-situ prepared sensors of pure SnO₂ and Pt doped SnO₂ are reproducible and have a very low detection limit for CO together with high sensor response. Control of the sensing layer thickness during the deposition process adds a further tool for tuning sensor performance in addition to its chemical composition. Furthermore, in principle, it is possible and straightforward to deposit a combination of different layers having different functions (e.g. filtering, sensing) in the same deposition process, enabling direct construction of fully functional sensors in very short times using a simple, clean and flexible fabrication process. Layer stacks of layers having different functionalities may easily be fabricated by changing the precursor substance during the deposition process and thus changing the aerosol composition.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a flame spray pyrolysis reactor;

FIG. 2 shows a schematic cross-section of a substrate and deposited layer

FIG. 3a-3d show scanning electron microscopy images of deposited sensing layers.

### DESCRIPTION OF THE PREFERRED EMBODIMENTS

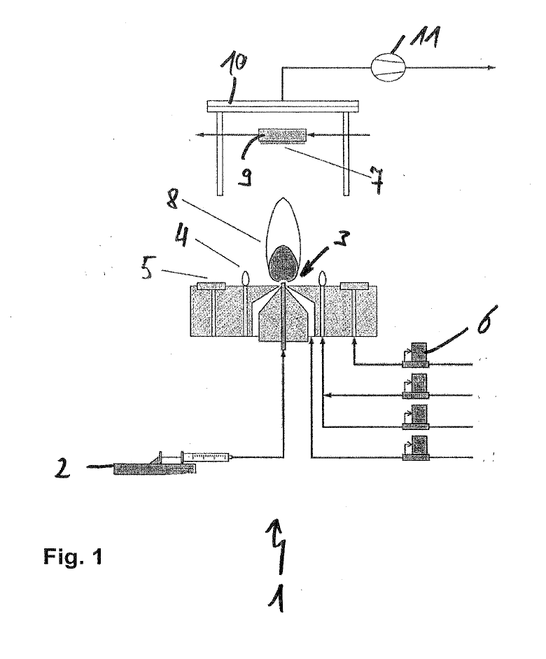

A schematic of a FSP reactor 1 is shown in FIG. 1. The liquid precursor substance is fed by a delivery system, in this case a syringe pump 2 with a constant feed rate of 5 ml/min through a capillary of an outside-mixing two-phase nozzle 3. The liquid is dispersed into fine droplets with 5 l/min oxygen maintaining a pressure drop of 1.5 bar at the nozzle exit. The liquid spray is ignited by a premixed methane/oxygen (1.5 l/min/3.2 l/min, respectively) flame ring 4 surrounding the nozzle exit. A sintered metal plate ring 5 issues additional 5 l/min of oxygen as a shield gas. All gas flow rates are controlled by calibrated mass flow controllers 6. A substrate 7 is disposed above the flame 8 and is held by a substrate holder 9, which is connected to cooling means. In the embodiment, the substrate holder 9 is embodied as water cooled copper block. The substrate holder 9 is located within a housing 10, which is connected to an exhaust vent 11.

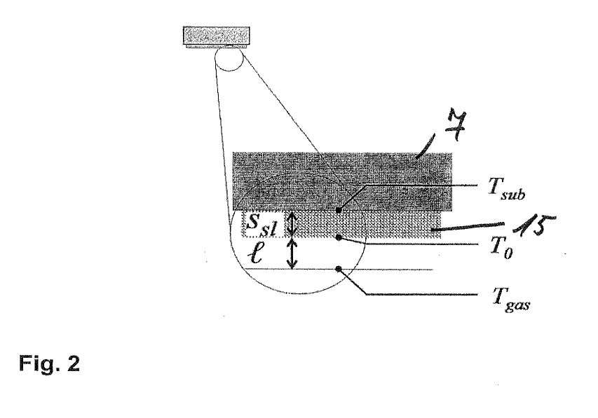

FIG. 2 shows the sensor substrate 7 having a constant temperature (T_{sub}) maintained by the water-cooling circuit. The gas temperature in front of the substrate (T_{gas}) is also constant and maintained by the heat of the spray flame 8. The surface temperature (T₀) of the sensing or particle layer 15 is equal to the substrate temperature at the beginning of the deposition process and approaches T_{gas} for large deposition heights (sₛᵢ) due to the low thermal conductivity of the growing particle layer.

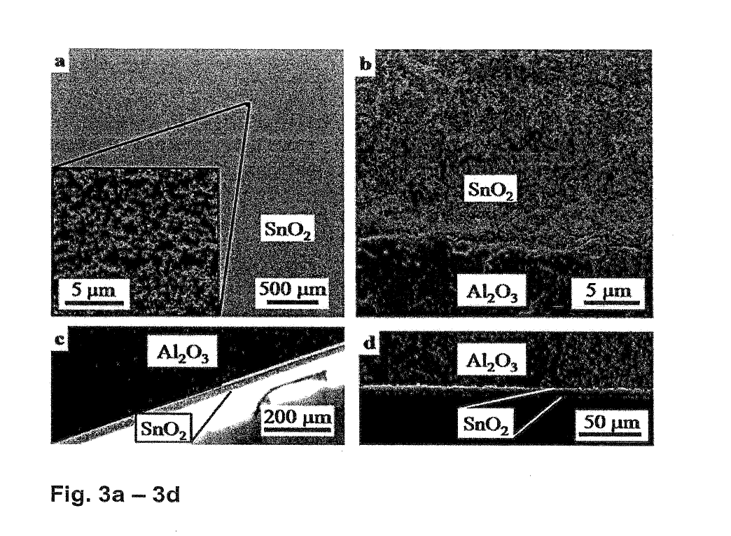

FIGS. 3a-3d summarize the scanning electron microscopy (SEM) analysis of an SnO₂ deposit on a sensor substrate. FIG. 3 (a) shows a 3×3 mm² area from the surface of a sensor deposit after 180 seconds deposition. Within that large area, the deposit surface is homogeneous. There are no detectable cracks and no variation in the layer structure. The homogeneity of the surface layer results from the direct particle deposition. Particles are dry-deposited from the aerosol phase which avoids the need for any post-deposition evaporation step to remove substances once the layer has formed. The substrate temperature of 120° C. avoids any water condensation which can lead to cracked films. This is a general advantage of the aerosol film preparation method in comparison to drop coating, dip and spin coating, and doctor blading where particles must be suspended initially in liquids. In such methods, the particle film is formed from rearrangement of the particles during solvent evaporation. This procedure causes internal stress in the plane of the substrate leading to bending of the substrate and/or cracking of the film.

The inset of FIG. 3a shows a 100× magnification of the tin oxide deposit which reveals a very porous structure. In-situ sintering or coalescence of the tin oxide particles within the film structure is not expected as the gas deposition temperature, T_{gas}=500° C., is much lower than the SnO₂ melting point (1130° C.). The homogeneity of the film is also observed under higher magnification which was validated at different locations across the deposit (not shown). FIG. 3(b) shows the same sensor from a side aspect (cleaved substrate). The dark zone is the corundum (substrate) while the conductive SnO₂ layer (deposit) appears brighter in the SEM image. The SnO₂ layer thickness is uniform over the observed cross section length of 0.7 mm (FIG. 3c). FIG. 3d shows a side view of a layer with 30 seconds deposition time for comparison with a 4 times higher magnification. Note the difference in thickness of 30 μm over 180 seconds (image c) to 9 μm over 30 seconds (image d). FIG. 3(d) also reveals the highly crystalline structure of the corundum substrate.

It will be understood that each of the elements described above, or two or more together, may also find a useful application in other types of methods differing from the types described above.

While the invention has been illustrated and described as embodied in a method of producing a gas sensor, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. Method of producing a gas sensor, comprising the steps of positioning a sensor substrate in a flame spray pyrolysis apparatus; generating an aerosol phase comprising sensing material nanoparticles by a flame spray pyrolysis (FSP) of a precursor substance; and depositing the sensing material particles contained in the aerosol, in particular nanoparticles of the sensing material, onto the sensor substrate directly from the aerosol phase to form a porous sensing layer on the sensor substrate.

2. Method according to claim 1, further comprising functionalizing the sensing material prior to the deposition.

3. Method according to claim 1, further comprising synthesizing pure and functionalized sensing material, in particular nanoparticles of pure and functionalized sensing material by flame spray pyrolysis.

4. Method according to claim 1, further comprising using as the sensing material a metal oxide and/or a mixed metal oxide and/or at least one of said materials functionalized with a noble metal, in particular SnO₂, ZnO/SnO₂ and/or Pt/SnO₂.

5. Method according to claim 1, further comprising, prior to the depositing the sensing material, prefabricating electrode assemblies on the sensor substrate.

6. Method according to claim 1, further comprising applying a mask to the substrate before the deposition in order to deposit the sensing material in a desired sensor area.

7. Method according to claim 1, further comprising controlling a substrate temperature during deposition, in particular keeping at a constant temperature, preferably at 120° C.

8. Method according to claim 1, further comprising locating the substrate at a stagnation point of an impinging jet of a flame.

9. Method according to claim 1 further comprising moving the substrate in spatial relation to a flame nozzle during deposition, in particular rotating.

10. Method according to claim 1, further comprising positioning the sensor substrate in a flame to give a deposition temperature which is lower than a melting point of the sensing material.

11. Method according to claim 1, further comprising depositing a stack of layers having different functionalities by changing an aerosol composition during the deposition of the sensing material on the sensor substrate.
